(19) United States
(12) Patent Application Publication
(10) Pub. No.: US 2019/0370739 A1
(43) Pub. Date: Dec. 5, 2019

(54) TRACKING OF OBJECTS IN LOGISTICS PROCESSES

(71) Applicant: blik GmbH, Munich (DE)

(72) Inventors: Victoria HAUZENEDER, Munchen (DE); Paul SAUER, Germering (DE); Philipp FRÖHLICH, Munich (DE); Franco SAWORSKI, Munchen (DE)

(73) Assignee: blik GmbH, Munich (DE)

(21) Appl. No.: 16/224,147

(22) Filed: Dec. 18, 2018

(30) Foreign Application Priority Data
May 29, 2018 (DE) 202018103014.0

(51) Int. Cl. G06Q 10/08; H04W 4/80; H04W 4/02; H04W 4/20

(52) U.S. Cl. CPC G06Q 10/0833; G06Q 10/087; H04W 4/20; H04W 4/023; H04W 4/80

(57) ABSTRACT

A system for tracking objects, the system including: at least one transmitter unit comprising a transmitting component which is adapted to transmit signals; and an electrical power supply device which is adapted to supply at least the transmitting component with electrical energy; at least one transmitter-receiver unit comprising a receiving element configured to receive signals from a transmitter unit; a data processing unit configured to process the signals received; and a transmitting element configured to transmit output signals; at least one data processing means configured to receive and process the output signals and to generate data therefrom; and at least one terminal; wherein the at least one data processing means is configured to transmit data to the at least one terminal; wherein the at least one terminal is configured to output information based on the transmitted data.

This application claims the benefit of German utility model Application No. 202018103014.0, filed May 29, 2018, in the German Patent and Trade Mark Office. All disclosures of the document(s) named above are incorporated herein in their entireties by reference.

The present invention is related to the tracking of objects in logistics processes.

Industrial companies often work with a large amount of inventory which they handle. For example, an automobile manufacturer needs a plurality of upstream products (e.g. doors, A, B and C pillars and engine components, to name but a few) in order to manufacture a car. These upstream products are supplied to the automobile manufacturer and the automobile manufacturer uses these upstream products to assemble the vehicle. For a complex product (e.g. a car) there are numerous upstream products and components which have to be assembled.

Such components or generally objects must be shipped and (usually) stored before the vehicle is assembled. The logistics of such upstream products can be relatively complex and prone to errors. For example, a user may not know exactly where an upstream product (or generally a component or an object) is located. In fact, the inventory entered in a system may differ significantly from the actual inventory.

This can make the production process susceptible to interruption and slow down the production or assembly process. Moreover, it can take up more storage space than is actually necessary.

It is an objective of the present technology to overcome or at least alleviate the shortcomings and disadvantages of the prior art. In other words, one of the objectives of the present invention is to improve the tracking of inventory.

These objectives are solved by the present invention.

According to a first aspect, the invention is related to a transmitter unit for use in an object tracking system. The transmitter unit comprises: a transmitting component adapted to transmit signals; and an electrical power supply device adapted to supply at least the transmitting component with electrical power. By means of a transmitter unit configured in this way, signals can be sent and objects—such as load carriers—can be tracked.

The transmitting component can be configured to transmit the signals over a wireless network.

The transmitting component can be configured to transmit the signals via a Personal Area Network.

The transmitting component can be configured to transmit the signals according to the IEEE802.15.4 standard.

In general, in the invention described herein, different frequency channels can be selected according to this standard. It may be particularly advantageous that the frequency channels used are selected so that they do not collide with other devices—for example with a WLAN network. This can be used to emit and receive the signals of the invention described herein.

The transmitting component may be configured to assume a first state in which the signals are sent at a first repetition rate, the first repetition rate preferably being in the range from 0.02 Hz to 1 Hz and particularly preferably in the range from 0.05 Hz to 0.2 Hz. In other words, the signals can be sent once per second up to every 50 seconds in the first state. This allows a relatively regular tracking of the transmitter unit and an object associated with it.

The transmitting component may be configured to assume a second state in which the signals are sent at a second repetition rate, the second repetition rate being lower than the first repetition rate, the second repetition rate preferably being in the range from 0.1 mHz to 20 mHz and particularly preferably in the range from 1 mHz to 4 mHz. In other words, the signals in the second state can be sent once per 10,000 seconds to once per 50 seconds and preferably once per 1,000 seconds (i.e. approx. every 17 minutes) to once per 250 seconds (i.e. approx. every 4 minutes).

In simple terms, when emitting information, the transmitting component may switch between a first (high) repetition rate and a second lower repetition rate. This allows the transmitting component to respond adaptively. For example, the high repetition rate may be selected when measured values change rapidly and the second lower repetition rate may be selected when the measured values are relatively constant. This permits reduction of data traffic if the measured values are relatively constant. In addition, the reduced repetition rate (which can also be commonly referred to as the transmission rate) can also result in less energy being consumed. It should be understood that transmitting data requires energy. If this is done less often (i.e. at a lower repetition rate), less energy is consumed per unit of time. This may lead to an extension of the operating time of the transmitter unit.

The electrical power supply device can be designed as a battery or accumulator.

The transmitter unit may further comprise a capacitor located between the electrical power supply device and the transmitting component to attenuate peak currents. It should be understood that the “arrangement between the electrical power supply device” and the transmitting component is an arrangement in the sense of an electronic circuit and not necessarily a spatial arrangement. Overall, it should be understood that in particular the emitting of signals is associated with a relatively high energy requirement. During the time in which the transmitter unit does not emit any signals, the transmitter unit is therefore operated at a relatively low power level. During the time in which the transmitter unit emits the signals, a relatively high power and thus a relatively high current is required. Peak currents can be attenuated by means of a capacitor arranged in the circuit between the power supply device and the transmitting component. This can protect components from peak currents and thus extend the service life of the transmitter unit.

The transmitter unit may comprise a temperature sensor.

The transmitter unit may comprise an acceleration sensor.

The transmitter unit may be configured so that the transmitting component transmits at the second repetition rate when an acceleration below an acceleration threshold is detected; and transmits at the first repetition rate when an acceleration above the acceleration threshold is detected. In other words, the transmitter unit thus transmits at a low repetition rate or transmission rate when a low acceleration is detected and at a high repetition rate when a high acceleration is detected. A low acceleration can on principle correlate with the fact that the transmitter unit is relatively stationary. If the transmitter unit does not move at all, its acceleration is zero. If the location of the transmitter unit is to be determined, it is not necessary in such a scenario that the location of the transmitter unit is determined often (that is, with a high repetition rate). If a relatively high acceleration is detected, this may indicate that the transmitter unit is moving. If, for example, the position of the transmitter unit is to be tracked, it may be advantageous that the transmitter unit emits signals relatively frequently in such a case.

Overall, this measure can therefore allow the transmitter unit to emit signals (which in this case allows safe tracking) at a relatively high transmission rate during motion (i.e. when it is likely that the transmitter unit changes position), and to emit signals at a relatively low transmission rate (which reduces power consumption and increases the operating time) when it is not moving (i.e. when it is less likely to change position).

The transmitter unit may comprise a housing surrounding at least the transmitting component and the electrical power supply device. This can protect the electronic components from environmental influences.

The housing can be waterproof. In particular, this may allow operation of the transmitter unit outdoors. This may be very advantageous, since the applications of the transmitter unit can be very broad.

The housing may comprise two housing sections and an O-ring by means of which the housing sections can be connected in a waterproof manner. This may be a particularly practical design of the housing, especially of the waterproof housing.

The transmitter unit may comprise a barometer, a magnetic sensor, a light sensor, a gas sensor and/or a hygrometer. Such sensors may be particularly useful if the transmitter unit is used in the food or chemical industry.

The transmitter unit may comprise a DC/DC converter configured to transform a first voltage from the electrical power supply device to a second voltage for operation of other electronic components.

The second voltage may be lower than the first voltage. This may allow the electronic components to be operated at a lower voltage and thus lower power, which may increase the operating time of the transmitter unit.

The signals can comprise identity signals of the transmitter unit. In other words, the signals may thus comprise information about which transmitter unit is concerned.

The signals may comprise temperature signals.

The signals may comprise states of the electrical power supply device, e.g. states of charge. This may make replacement of the power supply device or the transmitter unit possible before they are exhausted.

The signals may comprise acceleration signals.

The transmitter unit can be configured to be attached to a load carrier. Load carriers can be devices which are used in logistics in order to transport objects. For example, the load carrier may be a pallet, a container or a small load carrier.

The transmitter unit may have a weight in the range from 30 to 500 g, preferably 100 to 250 g, for example 150 to 200 g. The transmitter unit can thus be relatively compact, which can make it easier to handle.

The transmitter unit may not comprise a display.

The transmitter unit may not comprise a keyboard.

The transmitter unit can therefore be a relatively simply designed unit, which makes it less prone to errors and interference, and relatively robust.

The transmitter unit may comprise a receiving component adapted to receive signals.

The transmitter unit may comprise a control component.

The control unit may be configured, in response to the receiving component receiving a signal in a frequency band, to control the transmitting component so that the transmitting component does not transmit signals in that frequency band for at least one period of time.

This functionality can also be described as the design of a “Listen-Before-Talk” functionality. In simple terms, the transmitter unit can therefore detect by means of the receiving component whether signals are currently being transmitted in a frequency channel, i.e. whether this channel is currently in use (i.e. “busy”). If this is the case, the transmitter unit can block or delay transmission on this channel.

If the transmitter unit transmits signals on a frequency channel (or frequency band) which is currently in use, this may result in the signal not being evaluated well. In the worst case, the signals sent on this frequency channel may even be lost for the further analysis. In this scenario, the transmitter unit has sent signals which can no longer be used. Thus, energy has been used unnecessarily for the emission of signals. The measures described above can therefore again reduce the energy requirement and thus increase the operating time of the transmitter unit. Moreover, this can also ensure that the signals emitted do not (or less) interfere with each other and can be used more easily for further evaluation.

The control unit may be configured, in response to the receiving component receiving a signal in a frequency band and detecting an acceleration below a transmission threshold, to control the transmitting component so that the transmitting component does not transmit signals in that frequency band for at least one period of time.

This means that according to this embodiment, the frequency band is not automatically blocked by the transmitter unit if the frequency band is currently blocked, but only if a low acceleration value is detected at the same time period. In other words, this means for the transmitter unit: Do not transmit on this frequency channel if the frequency channel is currently occupied and a low acceleration is detected. This means that the frequency channel is on principle used temporarily by the transmitter unit, unless the transmitter unit detects a high acceleration. This causes the transmitter unit to transmit signals even though the corresponding frequency channel is used when the transmitter unit is in motion. In other words, this leads to a prioritization of signals from transmitter units in motion. This may be advantageous, as it is more likely for these transmitter units that a status that is to be tracked will change.

The control unit can be configured to change the first repetition rate and/or the second repetition rate in response to the receiving component receiving a signal.

By way of example, the first repetition rate could have a basic state of once per 10 seconds. If it is determined that the frequency channel in which the transmitter unit transmits is currently in use (i.e. “busy”), this repetition rate can be adjusted. According to a first embodiment, the repetition rate can be adjusted in such a way that its ratio to the repetition rate of the basic state can be described as an integer multiple. For example, the repetition rate could be halved to once per 20 seconds. In a second embodiment, its ratio to the first repetition rate can also not be described by an integer multiple, for example, the repetition rate could be set to once per 13 seconds. This can make different transmitter units blocking each other less likely.

The control unit can be configured to change the first repetition rate and/or the second repetition rate in response to the receiving component receiving a signal and detecting an acceleration below a transmission threshold.

Again, the mechanism can be designed so that at least one of the repetition rates is only adjusted if the transmitter unit detects a low acceleration. Again, this can lead to a prioritization of the transmitter units which are currently moving rapidly.

The power supply device can be of a modular design.

The transmitting component can comprise a PCB antenna or a screwable antenna.

The signals sent by the transmitting component may comprise pressure signals, magnetic signals, light signals, gas signals and/or signals related to air humidity.

According to a second aspect, the invention is related to a transmitter-receiver unit for use in an object tracking system. The transmitter-receiver unit comprises: a receiving element configured to receive signals from a transmitter unit; a data processing unit configured to process the signals received; and a transmitting element configured to transmit output signals.

In particular, such a transmitter-receiver unit can also be used to receive and process the signals of the transmitter unit described above. On this basis, output signals can be generated and retransmitted.

The receiving element can be configured to receive the signals over a wireless network. The receiving element can be configured to receive the signals via a Personal Area Network. The receiving element can be configured to receive the signals according to the IEEE802.15.4 standard.

The data processing means can be designed as a Linux-capable central processing unit (CPU) or as a microcontroller (MCU).

The data processing means can be designed as a single-board computer.

The data processing means can be designed as a Rasperry Pi computer.

The transmitting element is configured to transmit the output signals via a mobile radio connection.

The transmitter element can be configured to transmit the output signals via a WLAN/LAN connection.

The transmitter-receiver unit may comprise an electrical power supply device, which may be designed as a battery or accumulator.

The transmitter-receiver unit may comprise a housing surrounding at least the receiving element, the data processing unit and the transmitting element. Again, this can protect the electronic components from environmental influences.

The housing can be waterproof. This can make the transmitter-receiver unit particularly resistant and in particular allow it to be used outdoors.

The housing may comprise two housing sections and an O-ring by means of which the housing sections can be connected in a waterproof manner.

The data processing unit can be configured to determine a tracking status of the transmitter unit depending on the signals received by the receiving element from the transmitter unit; wherein the output signals comprise information about the identity of transmitter units and the tracking status of transmitter units.

It should be understood that the transmitter-receiver unit can receive signals from a transmitter unit when the transmitter unit is located near the transmitter-receiver unit. If the transmitter unit transmits a signal while it is located in a receiving area of the transmitter-receiver unit, this signal is received by the transmitter-receiver unit.

As described previously, the signal from the transmitter unit may especially comprise an identity signal from the transmitter unit, for example, that the transmitter unit is the transmitter unit with a certain serial number (for example, 42). If the transmitter-receiver unit receives such a signal, it can determine a positive tracking status of transmitter unit 42. The output signal could therefore comprise: “Transmitter unit 42 is registered with the transmitter-receiver unit.” It should be understood that the transmitter-receiver units could also be marked for example, with serial numbers. As a purely illustrative example, the output signal could then comprise: “Transmitter unit 42 is registered with the transmitter-receiver unit AH67.” Thus, tracking of the transmitter units can be permitted on the transmitter-receiver units.

The transmitter-receiver unit may comprise a position sensor which is configured to detect positions of the transmitter-receiver unit.

The position sensor can be a GPS sensor.

The output signals may comprise information about the positions of the transmitter-receiver unit.

Thus, further to the preceding example, the output signal may then comprise: “Transmitter unit 42 is registered with the transmitter-receiver unit AH67. This is located at 48° 8′ 6.45” N 11° 34′ 55.132″ E″. This may allow the position of a transmitter unit to be tracked.

The transmitter-receiver unit can be configured so that the transmitter element only transmits an output signal if at least one data point has changed by at least one threshold value compared to this data point as it was contained in the output signal transmitted last.

Again, this measure can reduce the energy consumption (here of the transmitter-receiver unit) and increase the corresponding operating time. This also reduces data traffic.

The at least one data point may comprise the tracking status determined by the data processing unit, and a change in the tracking status which exceeds one threshold number triggers the transmission of an output signal.

According to this embodiment, a change in the tracking status thus triggers the transmission of the output signal. This means that, further to the preceding example, the transmitter unit 42 may be tracked by the transmitter-receiver unit at a first time t1, but no longer at a later time t2. This could then trigger the transmission of an output signal.

It should be understood that there may be situations in which a transmitter unit is erroneously not tracked. For example, a signal may be disturbed. As a purely illustrative example, it is possible that the transmitter unit is used in a warehouse and is tracked by a transmitter-receiver unit in this warehouse. Here, it could happen that a forklift truck moves briefly between the transmitter unit and the transmitter-receiver unit and blocks the signal. Although the transmitter unit is still located in the warehouse, it would no longer be tracked by the transmitter-receiver unit.

In light of this, for example, it may be advantageous that it is not merely a simple change in the tracking status which triggers the transmission of the output signal, but that this change must exceed a threshold number. As an example of such a threshold number, the new tracking status could be determined repeatedly (for example 3 times).

This can prevent the output signal from already being triggered by random incorrect results.

The at least one data point may comprise a position of the transmitter-receiver unit.

This means, for example, that a change in the position of the transmitter-receiver unit can result in an output signal being sent. Again, it can be advantageous that not every small minor change triggers a transmission, but only those changes that exceed a threshold value to the last data point transmitted—for example a threshold value distance to the last position transmitted.

The data processing means can be configured to bundle the determined positions and the output signals can comprise the bundled positions.

The bundling of the determined positions may comprise a temporal averaging.

The data processing means can be configured to bundle the signals received to form bundled signals and the output signals can comprise the bundled signals.

The bundling of the signals received can comprise a temporal averaging.

By bundling the signals, data traffic and thus the energy used can again be reduced, which can again lead to an extension of the operating time.

The transmitter-receiver unit may have a weight in the range from 100 to 1000 g, for example 150 to 300 g.

The transmitter unit may not comprise a display.

The transmitter unit may not comprise a keyboard.

Again, this can make the invention particularly simple and less prone to errors.

According to a third aspect, the invention is related to a system for tracking objects. The system comprises: at least one transmitter unit according to the first aspect; at least one transmitter-receiver unit according to the second aspect; at least one data processing means configured to receive and process the output signals and to generate data therefrom; and at least one terminal; wherein the at least one data processing means is configured to transmit data to the at least one terminal; wherein the at least one terminal is configured to output information based on the transmitted data.

In other words, the transmitter unit and the transmitter-receiver unit can be used in a system which also comprises a data processing means and a terminal. In simple terms, the data processing means can receive and process the signals from the transmitter-receiver unit to generate data from them. These can be transferred to the terminal and can be displayed there.

In this way, information—such as the position of the transmitter units—can be output on the terminal, and a user can be enabled to track components.

The data processing means can be designed as a server.

The at least one terminal can comprise a computer, a laptop, a smartphone, a tablet PC, a smart speaker, augmented reality glasses and/or a smart watch.

Each of the at least one transmitter units may be assigned to a load carrier; and the at least one data processing means may be configured to determine a filling state of the at least one load carrier.

Accordingly, a user can not only be provided with the position of the load carrier, but also its loading state (e.g. “full” or “empty”).

The data processing means may be designed for each of the at least one transmitter units to determine the filling state of the load carrier based on a change in the tracking status of the transmitter unit associated with the load carrier.

The data processing means may be configured to change the filling state of the load carrier when a tracking status of the transmitter unit changes from positive to negative with respect to a first transmitter-receiver unit for a first threshold time or a first threshold number and a tracking status of the transmitter unit with respect to a second transmitter-receiver unit for a first threshold time or a first threshold number changes from negative to positive, i.e. when both conditions are met.

In simple terms, changing the tracked location of the load carrier can lead to an adjustment of the determined filling level. For example, the load carrier may be a load carrier for components in the automotive industry. As a purely illustrative example, a load carrier with an A-pillar is conceivable here. If such a load carrier arrives at the factory premises of the automobile manufacturer, it can be assumed that the load carrier is filled. If the load carrier is subsequently moved to a production area and then to the automobile manufacturer's yard, it can be assumed that the load carrier has changed its filling state from “full” to “empty”. Again, with this embodiment, threshold values can be used so that a random (and possibly incorrect) change in the tracking status does not lead to a change in the filling state.

This can be determined by the data processing means described and the filling state can be calculated in this way.

The data processing means can be configured to change the filling state of the load carrier if the tracking status of the transmitter unit with respect to the transmitter-receiver unit is positive and the positions determined for this transmitter-receiver unit meet a defined condition, i.e. if both conditions are met.

The defined condition can be a change of position from within a defined zone to outside the defined zone or vice versa.

An application example can be similar to what is known as geo-fencing. For example, the defined zone can comprise a supplier. For example, if a truck with a transmitter-receiver unit and a load carrier with a transmitter unit enters an area that is assigned to an automotive supplier for A-pillars and then leaves this area, it can be assumed that the filling state of the load carrier has changed from “empty” to “full”.

The information output by the at least one terminal can comprise a location of at least one transmitter unit.

The information output by the at least one terminal can comprise a filling state of at least one load carrier.

The information output by the at least one terminal can comprise a holding time of a transmitter unit at a location.

The information output by the at least one terminal can comprise a transport time of a transmitter unit from a first location to a second location.

The system can be configured so that the at least one terminal issues a push message in response to the transmitted data.

In other words, by means of the technology described here, it may be possible in particular that messages are transmitted to the terminal which open automatically or are displayed automatically. This can be particularly advantageous if critical or important messages are transmitted to the terminal and displayed there.

The push message can be output if a holding time of a transmitter unit has exceeded a threshold value.

The push message can be output when a transmitter unit has left a defined zone or has entered a predefined zone.

The system may be configured so that the data is transmitted in encrypted form from the at least one data processing means to the at least one terminal.

The encryption can be a transport layer encryption.

The data processing means may be configured to transmit the data to each of the at least one terminal depending on authentication on the respective terminal.

The at least one transmitter unit can comprise a plurality of transmitter groups, each transmitter group comprising at least one transmitter unit. The generated data may comprise data sections associated with at least one transmitter group but not all transmitter groups, and the data processing means may be configured to transmit a first data section to the first terminal and a second data section to a second terminal depending on authentication on a first terminal and a second terminal, the second data section being different from the first data section.

This embodiment allows the system to be used in particular by different user units (e.g. companies). By means of this system, a plurality of logistics processes from different companies can be tracked simultaneously. By means of the design described last, it is possible that the system is used simultaneously by different companies, wherein each company only tracking its own processes.

The system can comprise a plurality of transmitter units.

The system can comprise a plurality of transmitter-receiver units.

According to a fourth aspect, the invention is related to a method for tracking objects. The method uses a system according to the third aspect. Each of the at least one transmitter units may be attached to an object, for example a load carrier, and the method comprises: a transmitter unit transmits a signal to a transmitter-receiver unit; the transmitter-receiver unit processes the signal, generates an output signal and transmits the output signal to the data processing means; the data processing means receives the output signal, processes it and generates data therefrom; the data processing means transmits the data to a terminal; the terminal device outputs this data.

It should be understood that the features described above for the different units and the system can also be used for the method. In particular, the features which include a description that units or components are configured to perform certain steps may correspond to corresponding steps in the method.

According to a fifth aspect, the invention concerns use of the system according to the third aspect for tracking objects.

Each of the at least one transmitter units can be attached to an object and preferably to a load carrier.

At least one transmitter-receiver unit can be arranged in a truck.

At least one transmitter-receiver unit may be arranged on factory premises.

At least one transmitter-receiver unit may be arranged at a gate to the factory premises.

At least one transmitter-receiver unit may be arranged in a yard on the factory premises.

At least one transmitter-receiver unit may be arranged in a storage area on the factory premises.

At least one transmitter-receiver unit may be arranged in a production area on the factory premises.

Overall, the invention and the aspects described above also provide a technology which allows tracking, i.e. the tracking of objects and their states.

The present invention also comprises the following numbered embodiments.

Transmitter unit embodiments are enumerated below. These are abbreviated with “SE” and a number. Whenever reference is made here to transmitter unit embodiments, these embodiments are meant.

SE1. A transmitter unit for use in an object tracking system, the transmitter unit comprising:
a transmitting component which is adapted to transmit signals; and
an electrical power supply device which is adapted to supply at least the transmitting component with electrical energy.

SE2. The transmitter unit according to the preceding embodiment, wherein the transmitting component is configured to transmit the signals via a wireless network.

SE3. The transmitter unit according to the preceding embodiment, wherein the transmitting component is configured to transmit the signals via a Personal Area Network.

SE4. The transmitter unit according to the preceding embodiment, wherein the transmitting component is configured to transmit the signals according to the IEEE802.15.4 standard.

SE5. The transmitter unit according to any of the preceding embodiments, wherein the transmitting component is configured to assume a first state in which the signals are sent at a first repetition rate, the first repetition rate preferably being in the range from 0.02 Hz to 1 Hz and particularly preferably in the range from 0.05 Hz to 0.2 Hz.

SE6. The transmitter unit according to the preceding embodiment, wherein the transmitting component is configured to assume a second state in which the signals are sent at a second repetition rate, the second repetition rate being lower than the first repetition rate, the second repetition rate preferably being in the range from 0.1 mHz to 20 mHz and particularly preferably in the range from 1 mHz to 4 mHz.

SE7. The transmitter unit according to any of the preceding embodiments, wherein the electrical power supply device is designed as a battery or an accumulator.

SE8. The transmitter unit according to any of the preceding embodiments, wherein the transmitter unit further comprises a capacitor arranged between the electrical power supply device and the transmitting component to attenuate peak currents.

SE9. The transmitter unit according to any of the preceding embodiments, wherein the transmitter unit comprises a temperature sensor.

SE10. The transmitter unit according to any of the preceding embodiments, wherein the transmitter unit comprises an acceleration sensor.

SE11. The transmitter unit according to the preceding embodiment and with the features of the embodiment SE6, wherein the transmitter unit is configured in such a way that the transmitting component transmits at the second repetition rate when an acceleration below an acceleration threshold value is detected; and transmits at the first repetition rate when an acceleration above the acceleration threshold value is detected.

SE12. The transmitter unit according to any of the preceding embodiments, wherein the transmitter unit comprises a housing which surrounds at least the transmitting component and the electrical power supply device.

SE13. The transmitter unit according to the preceding embodiment wherein the housing is waterproof.

SE14. The transmitter unit according to the preceding embodiment, wherein the housing comprises two housing sections and an O-ring, by means of which the housing sections can be connected in a waterproof manner.

SE15. The transmitter unit according to any of the preceding embodiments, wherein the transmitter unit comprises a barometer, a magnetic sensor, a light sensor, a gas sensor and/or a hygrometer.

SE16. The transmitter unit according to any of the preceding embodiments, wherein the transmitter unit comprises a DC/DC converter configured to transform a first voltage from the electrical power supply device to a second voltage for operation of other electronic components.

SE17. The transmitter unit according to the preceding embodiment, wherein the second voltage is lower than the first voltage.

SE18. The transmitter unit according to any of the preceding embodiments, wherein the signals comprise identity signals of the transmitter unit.

SE19. The transmitter unit according to any of the preceding embodiments and with the features of the embodiment SE15, wherein the signals comprise temperature signals.

SE20. The transmitter unit according to any of the preceding embodiments, wherein the signals comprise states of the electrical power supply device.

SE21. The transmitter unit according to any of the preceding embodiments and with the features of the embodiment SE10, wherein the signals comprise acceleration signals.

SE22. The transmitter unit according to any of the preceding embodiments, wherein the transmitter unit is configured to be attached to a load carrier.

SE23. The transmitter unit according to any of the preceding embodiments, wherein the transmitter unit has a weight in the range of 30 to 500 g, preferably 100 to 250 g, for example 150 to 200 g.

SE24. The transmitter unit according to any of the preceding embodiments, wherein the transmitter unit does not comprise a display.

SE25. The transmitter unit according to any of the preceding embodiments, wherein the transmitter unit does not comprise a keyboard.

SE26. The transmitter unit according to any of the preceding embodiments, wherein the transmitter comprises a receiving component adapted to receive signals.

SE27. The transmitter unit according to the preceding embodiment, wherein the transmitter unit comprises a control component.

SE28. The transmitter unit according to the preceding embodiment, wherein the control unit is configured, in response to the receiving component receiving a signal in a frequency band, to control the transmitting component so that the transmitting component does not transmit signals in that frequency band for at least one period of time.

SE29. The transmitter unit according to the penultimate embodiment and with the features of the embodiment SE10, wherein the control unit is configured, in response to the receiving component receiving a signal in a frequency band and detecting an acceleration below a transmission threshold, to control the transmitting component so that the transmitting component does not transmit signals in that frequency band for at least one period of time.

SE30. The transmitter unit according to any of the preceding 3 embodiments and with the features of at least one of the embodiments SE5 and SE6, wherein the control unit is configured to change the first repetition rate and/or the second repetition rate in response to the receiving component receiving a signal.

SE31. The transmitter unit according to any of the embodiments SE27 to SE29 and with the features of the embodiment SE10 and at least one of the embodiments SE5 and SE6, wherein the control unit is configured to change the first repetition rate and/or the second repetition rate in response to the receiving component receiving a signal and an acceleration below a transmission threshold being detected.

SE32. The transmitter unit according to any of the preceding embodiments and with the features of the embodiment SE7, wherein the power supply device is of a modular design.

SE33. The transmitter unit according to any of the preceding embodiments, wherein the transmitter unit comprises a PCB antenna or a screwable antenna.

SE34. The transmitter unit according to any of the preceding embodiments with the features of the embodiment SE15, wherein the signals sent by the transmitting component comprise pressure signals, magnetic signals, light signals, gas signals and/or signals relating to an air humidity.

The transmitter-receiver unit embodiments are enumerated below. These are abbreviated with “SEE” and a number. Whenever reference is made here to transmitter-receiver unit embodiments (or SEE embodiments), these embodiments are meant.

SEE1. A transmitter-receiver unit for use in an object tracking system, the transmitter-receiver unit comprising:
a receiving element configured to receive signals from a transmitter unit;
a data processing unit configured to process the received signals;
a transmitting element configured to transmit output signals.

SEE2. The transmitter-receiver unit according to the preceding embodiment, wherein the receiving element is configured to receive the signals via a wireless network.

SEE3. The transmitter-receiver unit according to the preceding embodiment, wherein the receiving element is configured to receive the signals via a Personal Area Network.

SEE4. The transmitter-receiver unit according to the preceding embodiment, wherein the receiving element is configured to receive the signals according to the IEEE802.15.4 standard.

SEE5. The transmitter-receiver unit according to any of the preceding SEE embodiments, wherein the data processing means is designed as a Linux-capable central processing unit (CPU) or microcontroller (MCU).

SEE6. The transmitter-receiver unit according to any of the preceding SEE embodiments, wherein the data processing means is designed as a single-board computer.

SEE7. The transmitter-receiver unit according to any of the preceding SEE embodiments, wherein the data processing means is configured as a Rasperry Pi computer.

SEE8. The transmitter-receiver unit according to any of the preceding SEE embodiments, wherein the transmitter element is configured to transmit the output signals via a mobile radio connection.

SEE9. The transmitter-receiver unit according to any of the preceding SEE embodiments, wherein the transmitter element is configured to transmit the output signals via a WLAN and/or LAN connection.

SEE10. The transmitter-receiver unit according to any of the preceding SEE embodiments, wherein the transmitter-receiver unit comprises an electrical power supply device which can be designed as a battery or an accumulator.

SEE11. The transmitter-receiver unit according to any of the preceding SEE embodiments, wherein the transmitter-receiver unit comprises a housing surrounding at least the receiving element, the data processing unit and the transmitting element.

SEE12. The transmitter-receiver unit according to the preceding embodiment, wherein the housing is waterproof.

SEE13. The transmitter-receiver unit according to the preceding embodiment, wherein the housing comprises two housing sections and an O-ring, by means of which the housing sections can be connected in a waterproof manner.

SEE14. The transmitter-receiver unit according to any of the preceding SEE embodiments, wherein the data processing unit is configured to determine a tracking status of the transmitter unit depending on the signals received by the receiving element from the transmitter unit;

wherein the output signals comprise information about the identity of transmitter units and the tracking status of transmitter units.

SEE15. The transmitter-receiver unit according to any of the preceding SEE embodiments, wherein the transmitter-receiver unit comprises a position sensor which is configured to determine positions of the transmitter-receiver unit.

SEE16. The transmitter-receiver unit according to the preceding embodiment, wherein the position sensor is a GPS sensor.

SEE17. The transmitter-receiver unit according to any of the 2 preceding embodiments, wherein the output signals comprise information about the positions of the transmitter-receiver unit.

SEE18. The transmitter-receiver unit according to any of the preceding SEE embodiments, wherein the transmitter-receiver unit is configured so that the transmitter element only transmits an output signal if at least one data point has changed by at least one threshold value compared to this data point as it was contained in the last transmitted output signal.

SEE19. The transmitter-receiver unit according to the preceding embodiment and with the features of the embodiment SEE14, wherein the at least one data point comprises the tracking status determined by the data processing unit and a change in the tracking status which exceeds a threshold value triggering transmission of an output signal.

SEE20. The transmitter-receiver unit according to any of the 2 preceding embodiments and with the features of the embodiment SEE 15, wherein the at least one data point comprises a position of the transmitter-receiver unit.

SEE21. The transmitter-receiver unit according to any of the preceding embodiments with the features of the embodiment SEE 15, wherein the data processing means is configured to bundle the determined positions and the output signals comprising the bundled positions.

SEE22. The transmitter-receiver unit according to the preceding embodiment, wherein the bundling of the determined positions comprises a time-averaging.

SEE23. The transmitter-receiver unit according to any of the preceding SEE embodiments, wherein the data processing means is configured to bundle the received signals into bundled signals and the output signals comprising the bundled signals.

SEE24. The transmitter-receiver unit according to the preceding embodiment, wherein the bundling of the received signals comprises a time averaging.

SEE25. The transmitter-receiver unit according to any of the preceding SEE embodiments, wherein the transmitter-receiver unit has a weight in the range of 100 to 1000 g, for example 150 to 300 g.

SEE26. The transmitter-receiver unit according to any of the preceding SEE embodiments, wherein the transmitter unit does not comprise a display.

SEE27. The transmitter-receiver unit according to any of the preceding SEE embodiments, wherein the transmitter unit does not comprise a keyboard.

System embodiments are enumerated below. These are abbreviated with “S” and a number. Whenever reference is made here to system embodiments, these embodiments are meant.

S1. A system for tracking objects, the system comprising:
at least one transmitter unit according to any of the preceding transmitter unit embodiments;
at least one transmitter-receiver unit according to any of the preceding SEE embodiments,
at least one data processing means configured to receive and process the output signals and to generate data therefrom;
at least one terminal;
wherein the at least one data processing means is configured to transmit data to the at least one terminal;
wherein the at least one terminal is configured to output information based on the transmitted data.

S2. The system according to the preceding embodiment, wherein the data processing means is designed as a server.

S3. The system according to any of the preceding system embodiments, wherein the at least one terminal comprises a computer, a laptop, a smartphone, a tablet PC, a smart speaker, augmented reality glasses and/or a smart watch.

S4. The system according to any of the preceding system embodiments, wherein each of
the at least one transmitter units is assigned to one load carrier; and
the at least one data processing means is configured to determine a filling state of the at least one load carrier.

S5. The system according to the preceding embodiment, wherein the at least one transmitter-receiver unit comprises the features of embodiment SEE14, the data processing means for each of the at least one transmitter units being adapted to determine the filling state of the load carrier on the basis of a change in the tracking status of the transmitter unit which is assigned to the load carrier.

S6. The system according to the preceding embodiment, the data processing means being configured to change the filling state of the load carrier if
a tracking status of the transmitter unit with respect to a first transmitter-receiver unit changes from positive to negative for a first threshold time or a first threshold number, and
a tracking status of the transmitter unit with respect to a second transmitter-receiver unit changes from negative to positive for a first threshold time or a first threshold number.

S7. The system according to any of the 2 preceding embodiments, wherein the transmitter-receiver unit comprises the features of the embodiment SEE15, the data processing means being configured to change the filling state of the load carrier when
the tracking status of the transmitter unit with respect to the transmitter-receiver unit is positive, and
the positions determined for this transmitter-receiver unit fulfill a defined condition.

S8. The system according to the preceding embodiment, wherein the defined condition is a change of position from within a defined zone to outside the defined zone or vice versa.

S9. The system according to any of the preceding system embodiments, wherein the information output by the at least one terminal comprises a location of at least one transmitter unit.

S10. The system according to any of the preceding system embodiments, wherein the information output by the at least one terminal comprises a filling state of at least one load carrier.

S11. The system according to any of the preceding system embodiments, wherein the information output by the at least one terminal comprises a holding time of a transmitter unit at a location.

S12. The system according to any of the preceding system embodiments, wherein the information output by the at least one terminal comprises a transport time of a transmitter unit from a first location to a second location.

S13. The system according to any of the preceding system embodiments, wherein the system is configured so that the at least one terminal outputs a push message in response to the transmitted data.

S14. The system according to the preceding embodiment, wherein the push message is output if a holding time of a transmitter unit has exceeded a threshold value.

S15. The system according to any of the 2 preceding embodiments, wherein the push message is output when a transmitter unit has left a defined zone or has entered a predefined zone.

S16. The system according to any of the preceding system embodiments, wherein the system is configured so that the data is transmitted in encrypted form from the at least one data processing means to the at least one terminal.

S17. The system according to the preceding embodiment, where the encryption is a transport layer encryption.

S18. The system according to any of the preceding system embodiments, wherein the data processing means is configured to transmit the data to each of the at least one terminal depending on an authentication on the respective terminal.

S19. The system according to any of the preceding system embodiments, wherein the at least one transmitter unit comprises a plurality of transmitter groups,
wherein each transmitter group comprises at least one transmitter unit,
   wherein the generated data comprise data sections which are assigned to at least one transmitter group, but not all transmitter groups,
   wherein the data processing means is configured to transfer a first data section to the first terminal and a second data section to the second terminal depending on authentications on a first terminal and a second terminal,
wherein the second data section is different from the first data section.

S20. The system according to any of the preceding system embodiments, wherein the system comprises a plurality of transmitter units.

S21. The system according to any of the preceding system embodiments, wherein the system comprises a plurality of transmitter-receiver units.

Method embodiments are enumerated below. These are abbreviated with “V” and a number. Whenever reference is made here to process embodiments, these embodiments are meant.

V1. A method for tracking objects, the method using a system according to any of the preceding system embodiments,
wherein each of the at least one transmitter units is attached to an object and preferably to a load carrier, the method comprising:
a transmitter unit transmits a signal to a transmitter-receiver unit;
the transmitter-receiver unit processes the signal, generates an output signal and transmits the output signal to the data processing means;
the data processing means receives the output signal, processes it and generates data from it;
the data processing means transmits the data to a terminal;
the terminal outputs this data.

Use embodiments are enumerated below. These are abbreviated with “W” and a number.

Whenever reference is made here to use embodiments, these embodiments are meant.

W1. Use of the system according to any of the preceding system embodiments for tracking objects.

W2. Use according to the preceding embodiment, wherein each of the at least one transmitter units is attached to an object and preferably to a load carrier.

W3. Use according to any of the preceding use embodiments, wherein at least one transmitter-receiver unit is arranged in a truck.

W4. Use according to any of the preceding use embodiments, wherein at least one transmitter-receiver unit is arranged on factory premises.

W5. Use according to the preceding embodiment, wherein at least one transmitter-receiver unit is arranged at a gate to the factory premises.

W6. Use according to any of the 2 preceding embodiments, wherein at least one transmitter-receiver unit is arranged in a yard on the factory premises.

W7. Use according to any of the 3 preceding embodiments, wherein at least one transmitter-receiver unit is arranged in a storage area on the factory premises.

W8. Use according to any of the 4 preceding embodiments, wherein at least one transmitter-receiver unit is arranged in a production area on the factory premises.

The present invention is now described by means of exemplary drawings which illustrate but are not intended to limit the scope of application of the present invention.

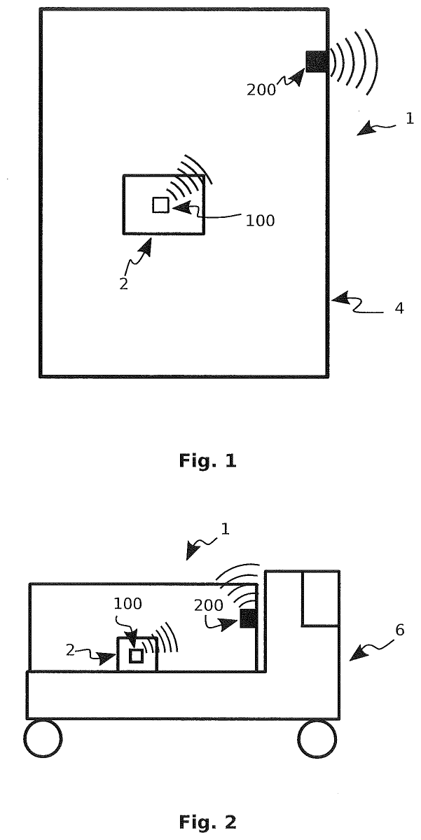

FIG. 1 depicts components of a system for tracking objects according to an embodiment of the invention;

FIG. 2 depicts further components of a system for tracking objects according to an embodiment of the invention; and

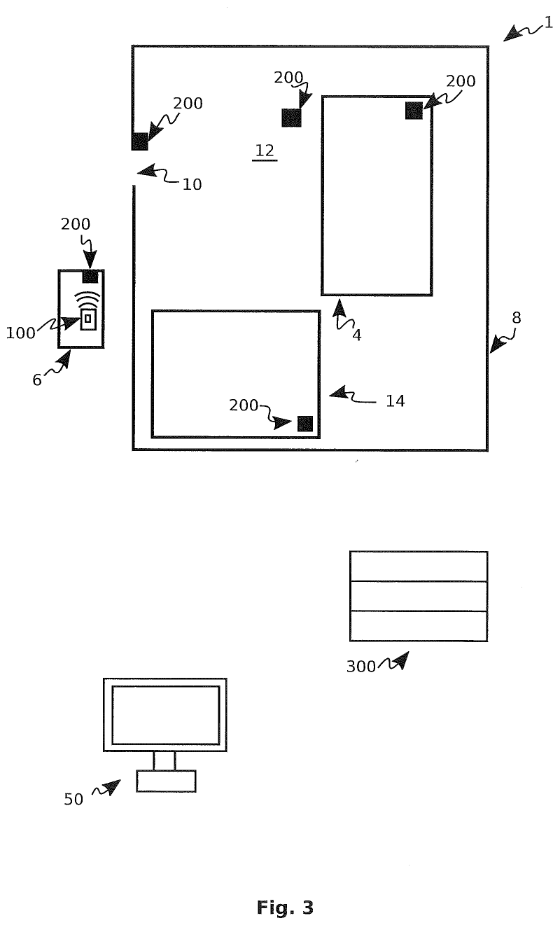

FIG. 3 depicts further components of a system for tracking objects according to an embodiment of the invention.

FIG. 1 depicts very generally a part of an inventory tracking system 1 according to a first embodiment of the present invention—the inventory tracking system 1 can also be referred to as system 1 for tracking objects or simply as system 1. System 1 comprises a transmitter unit 100 (which can also be referred to as transmitting unit 100) and a transmitter-receiver unit 200. The transmitting unit 100 can be attached to a load carrier 2. Overall, the illustrated part of system 1 is arranged in a warehouse 4. In very simple terms, the transmitting unit 100 can emit a signal which can be received by the transmitter-receiver unit 200. The transmitter-receiver unit 200 can only receive a signal from the transmitter unit 100 if the transmitter unit 100 is within a signal transmission range. In other words: if load carrier 2 with the transmitting unit 100 is not located in warehouse 4, the transmitter-receiver unit 200 does not receive a signal from this transmitting unit 100. Thus, the transmitter-receiver unit 200, which receives a signal from the transmitter unit 100, can determine that the transmitter unit 100 is located in warehouse 4. Thus, the presence of the transmitter unit 100 (and thus the assigned load carrier 2) can be tracked in warehouse 4. The transmitter-receiver unit 200 can also transmit a signal to an external unit, also called a data processing means, which may be designed as a server, for example, as described in more detail below.

FIG. 2 depicts very generally a further part of the inventory tracking system 1 according to the first embodiment of the present invention. The depicted part of the stock tracking system 1 comprises components which correspond to the components described in connection with FIG. 1 and which are provided with the same reference numbers. In the part depicted in FIG. 2, however, the components are located in truck 6.

FIG. 3 depicts another general illustration of Inventory Tracking System 1, which can also be referred to as Merchandise Management System 1. The depicted inventory tracking system 1 comprises 5 transmitter-receiver units 200, four of which are located on factory premises 8. In particular, one transmitter-receiver unit 200 is located at a gate 10 to the factory premises 8, one in the yard 12 on the factory premises 8, one in a warehouse 4 on the factory premises 8 and one in a production area 14 on the factory premises 8. Moreover, one of the transmitter-receiver units 200 is located in a truck 6. System 1 also comprises a server 300 configured to communicate with the transmitter-receiver units 200.

The system 1 depicted in FIG. 3 enables convenient product tracking, and an exemplary embodiment of the invention will now be described in more detail. Typically, the transmitter-receiver units 200 are configured to receive signals from the transmitting unit 100.

In the initial state, vehicle 6 can travel with the load carrier 2 to which the transmitting unit 100 is connected. Vehicle 6 is equipped with a transmitter-receiver unit 200. The transmitting unit 100 transmits a signal which is received by the transmitter-receiver unit 200. The signal of the transmitting unit 100 can comprise in particular an identity of the transmitting unit 100. Thus, the transmitter-receiver unit 200 “knows” that the transmitter unit 100 is located in its vicinity.

The transmitter-receiver unit 200 can communicate this to the server 300. Furthermore, the transmitter-receiver unit 200 can also comprise a positioning sensor, e.g. a GPS sensor, which determines a position of the transmitter-receiver unit 200. This location can also be communicated to the server 300. In this way, the transmitter-receiver unit 200 located in truck 6 can inform the server 300 of its location and the presence or absence of the transmitter unit 100 in its vicinity. The server can thus receive information about the location of the transmitter unit 100 (and thus of load carrier 2).

As soon as truck 6 arrives at gate 10, the transmitter-receiver unit 200 can receive a signal from transmitter unit 100 at gate 10. Here too, the transmitter-receiver unit 200 at gate 10 can inform the server 300 accordingly (possibly together with its location).

The same logic applies if the transmitter unit 100, which is assigned to load carrier 2, which can for example be designed as a container, transmits a signal which is received by the transmitter-receiver unit 200 located in yard 12, if a signal of the transmitter unit 100 is received by the transmitter-receiver unit 200 located in warehouse 4. In this way, a location of product carrier 2 can be tracked.

An exemplary embodiment describes a load carrier 2 with an A-pillar. The A-pillar is produced by an automotive supplier and then placed in a load carrier 2 equipped with a transmitter unit 100. The transmitting unit transmits a signal at predetermined time intervals, for example in time intervals of 10 seconds. The load carrier 2 with the A-pillar is then placed at the location of the automotive supplier in truck 6 (see FIG. 2).

The signal from the transmitting unit 100 is then received by the transmitter-receiver unit 200 of the truck. The transmitter-receiver unit 200 is additionally equipped with a GPS sensor and can thus determine its position. The transmitter-receiver unit 200 also comprises a transmitter, which can also be called a transmitter element, by means of which it can communicate with external components (for example with the server 300), for example via the mobile radio network. As a purely illustrative example, this communication can take place via LTE.

The emitting unit 100 thus transmits a signal received by the transmitter-receiver unit 200 and the transmitter-receiver unit 200 transmits a composite signal comprising an identity of the transmitting unit 100 and the position of the transmitter-receiver unit 200. This composite signal can be used to determine the position of the transmitting unit 100. In this way, the position of load carrier 2 can also be determined.

Furthermore, the technology described here can also predict or determine a loading state of load carrier 2 (e.g. “full” or “empty”). As described above, load carrier 2 is intended, for example, for transport of an A-pillar. If this load carrier 2 leaves the location of the automotive supplier, system 1 can assume the status of carrier 2 as “full”, since it is likely that the load carrier 2 had been filled with the corresponding equipment at the supplier's.

In cases where the factory premises of the automotive supplier are equipped with transmitter-receiver units 200, the logic described below can be used to determine the state of load carrier 2. However, such determining is also possible in cases where no transmitter-receiver units 200 are installed at the automotive supplier's. For example, a zone can be defined on a map which is assigned to the factory premises of the automotive supplier. As long as the signal sent by the transmitter-receiver unit 200 indicates that load carrier 2 is in this zone, system 1 can assume that load carrier 2 is on the supplier's factory premises. If the signal sent by the transmitter-receiver unit 200 changes from “within the zone” to “outside the zone”, system 1 can assume that load carrier 2 has left the supplier's factory premises. To avoid false positive results, this assumption can also be made later, namely when the composite signal reports a position outside the defined “zone” at least n times in succession, wherein n can be selected according to the conditions of the specific application.

In general, a system 1, in which the supplier's factory premises are not equipped with transmitter-receiver units 200, can also detect when a transmitter unit 100 and load carrier 2, to which the transmitting unit 100 is assigned, have left the supplier's. By means of the demonstrated logic, system 1 can assume such a load carrier 2 as filled.

System 1 may comprise a terminal 50 (see, for example, FIG. 3). The terminal 50 can be designed, for example, as a desktop PC, laptop, smartphone, tablet, smart watch, augmented reality glasses, barcode scanner or smart speaker and can output information to a user (for example visually or via loudspeakers).

The status of load carrier 2 can be displayed to the user via the terminal. In other words, the location of load carrier 2 and optionally the loading state of load carrier 2 can be output to the user. This allows the user to track where the load carrier 2 is and in which filling state it is.

In the example described, truck 6 can drive from the supplier's plant to the manufacturer's plant. While the truck is on this path, the transmitting unit 100 repeatedly sends signals received from the transmitter-receiver unit 200. The transmitter-receiver unit 200 sends another composite signal to the server 300, comprising the identity of the transmitting unit 100 and a position of the transmitter-receiver unit 200. Server 300 can also determine the state of loading state of the load carrier (for example using the method described above). Server 300 sends the corresponding information to terminal 50, which can output this information. Accordingly, the terminal outputs the corresponding information to a user. This can allow the location and the filling state of a load carrier to be tracked during transport.

At the end of the journey, truck 6 arrives at the automobile manufacturer's factory premises 8—see FIG. 3. If truck 6 is located near gate 10 to the factory premises, the signal from transmitting unit 100 is also received by transmitter-receiver unit 200 at gate 10. This transmitter-receiver unit 200 (as well as the other transmitter-receiver units 200 discussed here) is usually designed in the same way as the previously discussed transmitter-receiver units 200. Again, the transmitter-receiver unit 200 transmits the identity of the transmitting unit 100 and the position of the transmitter-receiver unit 200 to the server 300 at gate 10. Server 300 now “knows” that the transmitting unit 100 is located at the gate—again, this information can be transmitted to the terminal 50 and output to a user here.

The truck passes gate 10 and drives on to a yard 12. This yard 12 is also equipped with a transmitter-receiver unit 200. If the transmitter unit 100 is located near the transmitter-receiver unit 200 of yard 12, this transmitter-receiver unit 200 registers this again and transmits it to the server 300, which can transmit the corresponding information to the terminal 50 where this information is output.

In yard 12, load carrier 2 can be unloaded from truck 6 and then transferred to a warehouse 4. Again, this warehouse 4 can be equipped with a transmitter-receiver unit 200. When the load carrier 2 is in warehouse 4, the transmitter-receiver unit 200 of warehouse 4 can receive the signals of the transmitter unit 100 again. Again, the transmitter-receiver unit 200 can transmit this information and its position to the server 300, which can forward this information to the terminal 50, which can output this information.

The factory premises 8 can also have a production area 14 (for example, a production hall 14). If the exemplary A-pillar is to be installed, the load carrier 2 can be moved with the A-pillar from warehouse 4 to production area 14. Production area 14 also has a transmitter-receiver unit 200 in the exemplary embodiment depicted. If the transmitting unit 100 is in production area 14, the transmitter-receiver unit 200 of production area 14 can receive the signals of the transmitting unit 100. Similar to the scenarios described above, the transmitter-receiver unit 200 in production area 14 sends information to the server 300, which transmits it to the terminal 50, by which it can then be output.

Usually the state of load carrier 2 changes in production area 14. If load carrier 2 is placed in production area 14, load carrier 2 is typically filled. In production area 14, the equipment (for example the A-pillar) is taken from load carrier 2 and used for production. If load carrier 2 leaves production area 14, system 1 can thus assume that load carrier 2 is “empty”.

After load carrier 2 was in production area 14, it can be moved to yard 12, for example. First (while the load carrier is in production area 14), the transmitter-receiver unit 200 in production area 14 receives a signal from the transmitting unit 100, which is assigned to load carrier 2.

The transmitter-receiver unit 200 sends a corresponding composite signal to server 300, which forwards the corresponding information to terminal 50. Terminal 50 outputs corresponding information to a user.

Subsequently, load carrier 2 is moved from production area 14 to yard 12. Again, the transmitter-receiver unit 200 in yard 12 can send corresponding information to server 300.

In addition to the position of load carrier 2, the server 300 can also adapt the filling state of load carrier 2 on this basis. As described, the filling state of load carrier 2 was adjusted last when system 1 registered that load carrier 2 had left a zone assigned to the supplier. Load carrier 2 has since been registered as “filled” in system 1.

After load carrier 2 has left production area 14, system 1 can assume that the load in load carrier 2 has been removed and thus set the state of load carrier 2 to “empty”.

Similar to the procedure described above (in which the state of the load carrier was set to “filled” when leaving the supplier's zone), system 1 and in particular server 300 can set the filling state to “empty” when load carrier 2 is registered for the first time in an area other than production area 14 after load carrier 2 was in production area 14. Again, mechanisms can be used here—in order to avoid incorrect results—in which not only one-time registration in another area is necessary, but repeated n-times registration. It should be understood that this filling state can also be transmitted to terminal 50 and is output there.

Subsequently, load carrier 2 can be picked up again in a truck 6 and taken from there via the gate to the supplier's and filled there—the steps described above can thus be repeated accordingly.

It should be understood that by means of this technology a system 1 is provided, which significantly simplifies tracking components. The user can constantly retrieve information on where a load carrier 2 is located and what its filling state is.

The advantageous designs of system 1 and its individual components are described below.

The (at least one) transmitting unit 100 and the transmitter-receiver units 200 can communicate with each other via wireless networks, especially via wireless Personal Area Networks. For example, this communication can be performed using the IEEE802.15.4 standard. Embodiments of the technology described here select the frequency channels available in this standard in such a way that the corresponding channel does not compete with existing WLAN networks in the area, as far as possible. This can improve data transmission. The corresponding flexibility is particularly advantageous compared to embodiments which use Bluetooth.

As described above, the transmitter unit 100 can send signals at preset time intervals, for example every 10 seconds. For this purpose, the transmitter unit 100 comprises a transmitting component. The transmitter unit 100 is usually attached to a load carrier 2, for example. Thus, it is particularly advantageous if the transmitter unit 100 is not dependent on the power supply grid. Therefore, the transmitter unit 100 usually comprises a battery or accumulator. In addition, the transmitter unit 100 can comprise a capacitor to absorb current peaks during transmission based on the battery.

When the transmitter unit sends a signal received by a transmitter-receiver unit 200 (if a transmitter-receiver unit 200 is within reception range), relatively high power and relatively high currents are required for this operation. Such peak currents can be compensated by means of the described capacitor.

The transmitter unit 100 may comprise a temperature sensor. In embodiments in which the transmitter unit 100 comprises a temperature sensor, the signals sent from the transmitter unit 100 to the transmitter-receiver unit 200 and the composite signal sent from the transmitter-receiver unit 200 to the server 300 may also comprise the temperature signals. The corresponding information can then also be transferred from server 300 to terminal 50 and output to a user here.

Moreover, the transmitter unit 100 can also transmit the status of its battery or accumulator to the transmitter-receiver units 200.

The transmitter unit 100 may also comprise an acceleration sensor. Again, the corresponding data can be transmitted to the transmitter-receiver unit 200. However, the acceleration sensor can also be used for other functionalities. The data from the acceleration sensor can especially be used to control the transmitting component. In particular, a transmission frequency or a repetition rate of the transmitting component can be controlled. For example, this control may work as follows: if the acceleration is below a threshold value, the transmitting component transmits at a first transmission frequency (for example, every 10 minutes). If the acceleration is greater than or equal to the threshold value, the transmitting component transmits with a second transmit frequency greater than the first transmit frequency (for example, every 10 seconds). This ensures that the transmitting component transmits signals with a high repetition rate when the transmitter unit is moving—this allows position changes (as the transmitter unit 100 is registered by different transmitter-receiver units 200) to be detected quickly. At the same time, the features described may cause the transmitter unit 100 to send a signal rarely when it is not moving. It should be obvious that in this case, it is less likely that it changes its position and is registered by different transmitter-receiver units 200. At the same time, the concept described above means that the transmitter unit 100 does not emit more signals than are necessary. Since the transmission of signals is associated with relatively high power, the power required can thus be reduced and the operating time of the transmitter unit 100 can be increased. If there are several transmitter units 100 in the system, this also ensures that the transmission signal from fast-moving transmitter units 100 is not blocked by stationary transmitter units 100. In other words, the transmitter units 100 designed in this way transmit less often when small accelerations are detected, i.e. they do not move at all (or relatively little). In addition to the fact that this reduces the power required and thus increases the operating time of the transmitter units 100, less data is sent, resulting in less “traffic” in the frequency channels used.

The transmitter units 100 can also comprise a “listen before talk” component or function which ensures that no other signals are currently being transmitted on a channel if the sensor unit 100 wants to transmit a signal. If a signal is already being transmitted, the channel is considered as blocked and the system waits for a few milliseconds before it tries to transmit again. Detection of a blocked channel may be used to reduce the transmission frequency. This reduction can be achieved by a fixed constant (e.g. a halving) or prioritized depending on the speed of movement (i.e. depending on values provided by the acceleration sensor). For example, with a constant factor, a non-moving transmitter unit (i.e. a transmitter unit with a current acceleration value below a threshold value) may transmit every 20 minutes only, instead of every 10 minutes and a moving transmitter unit (i.e. a transmitter unit with a current acceleration value greater than or equal to the threshold value) can only transmit every 20 seconds instead of every 10 seconds. This adaptation to the quantity of transmitter units 100 within the range of a receiver (i.e. a transmitter-receiver unit 100) means that a signal can be received at the transmitter-receiver unit 200 even with a large number of transmitter units 100.

In other words, the transmitter unit 100 may also comprise a receiving component or “listening component” adapted to receive signals on frequency bands. In addition, the transmitter unit 100 may comprise a control component. The control component may be adapted to prevent or delay the transmitting component of the transmitter unit from transmitting signals on a frequency band when the receiving component of the transmitter unit is receiving or has recently received a signal on that frequency band. In other words, the reception of a signal in a frequency band by the receiving component may result in this frequency band being “blocked” for a specified time. The control component can be adapted to control the transmitting component to transmit on another frequency channel or to adjust its repetition rate. For example, the repetition rate can be adjusted from every 10 seconds (=0.1 Hz) to every 20 seconds (=0.05 Hz). In some embodiments, it is also possible that the repetition rate is adjusted to a value which is not in an integer relation to the initial value. For example, such an adjustment could be from output value every 10 seconds (=0.1 Hz) to every 13 seconds (=1/13 Hz). This can make it less likely that different transmitter units are transmitting at the same time.

The transmitter unit 100 may also comprise a housing that can surround the electronic components of the transmitter unit 100. The housing can be made of plastic, for example. In particular, the housing can be waterproof so that the components inside the housing are protected against splash water (e.g. rain). In an exemplary embodiment, the housing can comprise two housing sections which can be connected to each other. Moreover, the housing can comprise a packing ring for waterproof connection of the housing sections. This ensures that the transmitter unit 100 is also suitable for outdoor use. Overall, the reliability and service life of the transmitter unit 100 can also be increased in this way.

The transmitter unit 100 may also have a DC/DC converter. The DC/DC converter can convert a first voltage which it receives from an energy source (such as a battery or an accumulator) on the transmitter unit 100 into a second voltage. For example, the DC/DC converter can transform voltage from 3 VDC to 1.8 VDC and thus supply the remaining components. This measure can also reduce the power used and increase the operating time accordingly.

As described above, the described system 1 comprises at least one and usually a number of transmitter-receiver units 200. In simple terms, the transmitter-receiver unit 200 receives the signals from the transmitter unit 100 (for example, over a wireless network, such as a Personal Area Network) and can communicate data to the server 300 (for example, via LTE).

The transmitter-receiver unit 200 may comprise data processing equipment. By means of this data processing unit, the signals can be processed by the transmitter unit 100. For example, the data processing unit can average or generally bundle the signals from the transmitter units 100 and then retransmit only bundled (e.g. averaged) signals to the server 300. This may reduce the transmitted data from the transmitter-receiver unit 200 to the server and thus reduce the energy consumption of the transmitter-receiver unit 200. As a purely illustrative example, the data processing unit can be designed as a Rasperry Pi computer.

For example, it may be possible that the transmitter-receiver unit 200 does not continuously transmit data to the server 300, but only if at least one data point of the transmitter-receiver unit 200 has changed. Possible data points which can justify such a transmission may be, for example: a tracking status of a transmitter unit 100 or a position of the transmitter-receiver unit 200.

To illustrate this, first a spatially fixed transmitter-receiver unit 200 is considered, for example the transmitter-receiver unit 200 in warehouse 4 in FIG. 3. Since it is fixed, it will usually not change its position, meaning that this data point is constant. In the method described above, the transmitter unit 100 is not initially located in a “receiving area” of the transmitter-receiver unit 200 in warehouse 4, thus, this transmitter unit 100 is not initially registered with this transmitter-receiver unit 200. When load carrier 2 is moved to warehouse 4 with transmitter unit 100, the corresponding transmitter-receiver unit 200 (in the method described) receives the signal from transmitter unit 100 for the first time. Thus, the data point tracking status for this transmitter unit 100 changes from “non-tracked” to “tracked” at this moment. When load carrier 2 is subsequently moved from warehouse 4 to production area 14, the tracking status of the corresponding transmitter unit 100 changes from “tracked” to “non-tracked” with regard to transmitter-receiver unit 200 in warehouse 4.

These status changes can be used as data points which trigger transmission from the transceiver unit 200 to the server 300.

To make the method and the corresponding system more robust and less error-prone, it is possible in turn that the trigger for transmitting the status change is not triggered by a single change. For example, it is possible that load carrier 2 with transmitter unit 100 is located in warehouse 4, but its signal does not reach transmitter-receiver unit 200—for example, because a forklift truck is briefly arranged between transmitter unit 100 and transmitter-receiver unit 200. To avoid such errors, it is possible that the trigger is not activated by a one-time status change. Instead, a threshold value can be used again which must be exceeded before the trigger is activated. This can be particularly advantageous for the status change from “tracked” to “non-tracked”. For example, the logic associated with this could be as follows: Define a threshold time. If a transmitter-receiver unit 200 does not detect a signal from a transmitter unit 100 for a period of time longer than the threshold time, set this transmitter unit 100 to “non-tracked”. This may reduce false negative results—which ultimately results in the transmitter-receiver units 200 transmitting less data to the server 300 and consequently also in a lower power consumption of the transmitter-receiver units 200.

In the case of a transmitter-receiver unit 200 which is not spatially bound (see, for example, the transmitter-receiver unit 200 in truck 6), the data point position of the transmitter-receiver unit 200 can also change. As described above, the transmitter-receiver units 200 usually have one GPS sensor each. Changing this data point can also trigger a transmission from the transmitter-receiver unit 200 to the server 300. Again, a threshold value can be set for this. In particular, the threshold value can be defined as the distance to the last position transmitted to the server. I.e. the logic behind it can be formulated as follows: If the distance from the current position to the last position transmitted to the server is greater than the threshold value, transmit the current position. Again, the transmitted data and the associated energy requirements can thus be reduced.

In some embodiments, the transmitter-receiver units 200 may comprise a battery or an accumulator—this may be advantageous as the transmitter-receiver units 200 are then not dependent on an external power supply. In other embodiments, however, the transmitter-receiver units 200 can also be supplied with power via an external power supply.

The transmitter-receiver unit 200 usually also comprises a housing (made of plastic, for example) which can be waterproof for similar reasons as above. Again, the housing can comprise two housing sections and optionally include an O-ring to connect the housing sections together in a waterproof manner.

As described above, the server 300 can receive data from the transmitter-receiver units 200. This data may include at least one of the following data points: Position of the respective transmitter-receiver units 200, registration status of the transmitter units 100 with respect to the transmitter-receiver units 200 and battery status of the transmitter units 100 registered with the transmitter-receiver units 200. The server 300 can also determine the filling state of load carrier 2 from this, as described above.

Based on this, further analyses can also be carried out. For example, the server 300 can determine transport and dwell times of load carrier 2—both for the individual load carrier 2 and for a plurality of load carriers (for example by calculating the average value). For example, bottlenecks can be determined in system 1.

The corresponding data can then be made available to a user via the terminal 50.

In particular, terminal 50 can output at least one of the following pieces of information: current position of transmitter units 100 or load carrier 2 to which the transmitter unit 100 is assigned; filling state of load carrier 2; battery status of transmitter unit 100; time during which a load carrier 2 has not moved (i.e. downtime); time which a load carrier 2 has taken for transport from a first location (for example the supplier's location) to a second location (for example the factory premises); comparisons of values with targets; and/or automated bookings of goods.

In particular, system 1 can also be designed in such a way that the terminal 50 issues a message to the user in certain situations, for example in the form of a push message (via an app, SMS or e-mail). This can be a warning message, for example. These messages are usually generated by server 300 and then transmitted to terminal 50. Situations leading to such a message could be, for example: a load carrier 2 and the associated transmitter unit 100 have not been moved over a period of time exceeding a threshold value; a load carrier 2 and the associated transmitter unit 100 have left a defined area (“Load carrier A has left your factory premises.” or “Load carrier B has left the supplier's and is on its way to you.”).

As described above, data is transferred from server 300 to terminal 50 and can be output here to a user.

It should be understood that the described system 1 usually comprises a plurality of transmitter units 100 and transmitter-receiver units 200 which are tracked. By means of the described system 1, it is possible to track different load carriers 2 (and goods) of a company, for example.

However, the described system 1 can also be used for more than one company at the same time. The same technology can also be used by a plurality of customers. In such a system 1, a plurality of terminals 50 have access to the data in server 300.

It should be understood that in this case, it is desirable if not every terminal has access to all data.

Accordingly, the data on server 300 can be divided into different data areas. A corresponding subdivision can also be made at the level of the transmitter units 100 (and optionally also) at the level of the transmitter-receiver units 200.

In embodiments of the technology described here, it is possible that only part of the data on server 300 is transmitted to a terminal 50 and is displayed there, whereas another part of the data is not visible for that terminal 50.

For example, this can be achieved via a user authentication performed on terminal 50—the user authentication is granted certain rights which allow access to some (but not all) of the data on the server 300.

Thus, the system described above can be used by different customers at the same time without any confidential information being exchanged.

In general, the data can be transmitted from server 300 to the terminal 50 (or the terminals) in encrypted form, for example via TLS.

By means of the technology described here, it is therefore possible to track objects—for example in a logistics chain—safely, reliably and in a user-friendly manner.

This document often describes that components are “configured” for a particular action. It should be understood that the present technology places particular emphasis on data processing and data transmission. In this context, it is pointed out that the term “configured” for a particular action means that the corresponding component is programmed to perform the corresponding action.

When a relative term such as “approximately”, “substantially” or “approximate” is used in this description, such a term should be interpreted to include the exact term. This means, for example, that “essentially straight” should be interpreted so that it includes “(exactly) straight”.

Whenever steps were recited in the above description or also in the appended claims, it should be noted that the order in which the steps are listed in this text may be random. That means, unless otherwise indicated or obvious to the skilled person, the order in which the steps are listed may be random. That means that, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). If one step (X) precedes another step (Z), this does not mean that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above explanations a preferred embodiment with reference to the enclosed drawings was described, the skilled person will understand that this embodiment was made available for illustrative purposes only and should in no case be interpreted in such a way that it limits the scope of the present invention, which is defined by the claims.

1. A system for tracking objects, the system comprising:
at least one transmitter unit comprising
a transmitting component which is adapted to transmit signals; and
an electrical power supply device which is adapted to supply at least the transmitting component with electrical energy;
at least one transmitter-receiver unit comprising
a receiving element configured to receive signals from a transmitter unit;
a data processing unit configured to process the signals received; and
a transmitting element configured to transmit output signals;
at least one data processing means configured to receive and process the output signals and to generate data therefrom; and
at least one terminal;
wherein the at least one data processing means is configured to transmit data to the at least one terminal;
wherein the at least one terminal is configured to output information based on the transmitted data.

2. The system according to claim 1, wherein the transmitting component is configured to transmit the signals and the receiving element of the transmitter-receiver unit is configured to receive the signals, via a wireless network.

3. The system according to claim 1, wherein the transmitting component is configured to assume
a first state in which the signals are sent at a first repetition rate;
a second state in which the signals are sent at a second repetition rate, the second
repetition rate being lower than the first repetition rate; and
wherein the transmitter unit is configured in such a way that the transmitting component
transmits at the second repetition rate when an acceleration below an acceleration threshold value is detected; and
transmits at the first repetition rate when an acceleration above the acceleration threshold value is detected.

4. The system according to claim 1, wherein the transmitter unit comprises at least one of a barometer, a magnetic sensor, a light sensor, a gas sensor, or a hygrometer.

5. The system according to claim 1, wherein the transmitter unit comprises a DC/DC converter configured to transform a first voltage from the electrical power supply device to a second voltage for operation of other electronic components, and wherein the second voltage is lower than the first voltage.

6. The system according to claim 1, wherein the signals comprise at least one of
identity signals of the transmitter unit;
temperature signals;
states of the electrical power supply device; or
acceleration signals.

7. The system according to claim 1, wherein the transmitter unit further comprises a capacitor arranged between the electrical power supply device and the transmitting component to attenuate peak currents.

8. The system according to claim 1, wherein the transmitter unit is configured to transmit the output signals via at least of one
a mobile radio connection; or
a WLAN and/or LAN connection.

9. The system according to claim 1, wherein the transmitter unit comprises at least one of
a temperature sensor; or
an acceleration sensor.

10. The system according to claim 1,
wherein the data processing unit is configured to determine a tracking status of the transmitter unit depending on the signals received by the receiving element from the transmitter unit;
wherein the output signals comprise information about the identity of transmitter units and the tracking status of transmitter units.

11. The system according to claim 1, wherein the transmitter-receiver unit is configured so that the transmitter element only transmits an output signal if at least one data point has changed by at least one threshold value compared to this data point as it was contained in the last transmitted output signal, and
wherein the at least one data point comprises the tracking status determined by the data processing unit and a change in the tracking status which exceeds a threshold value triggers transmission of an output signal.

12. The system according to claim 1, wherein the electrical power supply device is designed as a battery or an accumulator.

13. The system according to claim 1, wherein the transmitter unit further comprises a housing surrounding at least the transmitting component and the electrical power supply device of the transmitter unit; and
wherein the transmitter-receiving unit comprises a housing surrounding at least the receiving element, the data processing unit and the transmitting element of the transmitter-receiver unit,
wherein the housings are waterproof, wherein each of the housings comprises two housing sections and an O-ring, by means of which the housing sections can be connected in a waterproof manner.

14. The system according to claim 3, wherein the transmitter unit comprises a receiving component adapted to receive signals and a control unit, wherein the control unit is configured to change the first repetition rate and/or the second repetition rate in response to the receiving component receiving a signal in a frequency band.

15. The system according to claim 10, wherein each of the at least one transmitter units is assigned to one load carrier; and
the at least one data processing means is configured to determine a filling state of the at least one load carrier.

16. The system according to claim 15, wherein the data processing means is adapted to determine for each of the at least one transmitter units the filling state of the load carrier on the basis of a change in the tracking status of the transmitter unit which is assigned to the load carrier.

17. The system according to claim 16, wherein the data processing means is configured to change the filling state of the load carrier if
a tracking status of the transmitter unit with respect to a first transmitter-receiver unit changes from positive to negative for a first threshold time or a first threshold number, and
a tracking status of the transmitter unit with respect to a second transmitter-receiver unit changes from negative to positive for a first threshold time or a first threshold number.

18. The system according to claim 16, wherein the transmitter-receiver unit comprises a position sensor which is configured to determine positions of the transmitter-receiver unit, wherein the data processing means is configured to change the filling state of the load carrier when
the tracking status of the transmitter unit with respect to the transmitter-receiver unit is positive, and
the positions determined for this transmitter-receiver unit fulfill a defined condition.

19. The system according to claim 1, wherein the at least one transmitter unit comprises a plurality of transmitter groups,
wherein each transmitter group comprises at least one transmitter unit,
wherein the generated data comprise data sections which are assigned to at least one transmitter group, but not all transmitter groups,
wherein the data processing means is configured to transfer a first data section to a first terminal and a second data section to a second terminal depending on authentications on the first terminal and the second terminal,
wherein the second data section is different from the first data section.

20. A method for tracking objects, the method using a system according to claim 1,
wherein each of the at least one transmitter units is attached to an object and preferably to a load carrier, the method comprising:
a transmitter unit transmits a signal to a transmitter-receiver unit;
the transmitter-receiver unit processes the signal, generates an output signal and transmits the output signal to the data processing means;
the data processing means receives the output signal, processes it the output signal and generates the data from the output signal;
the data processing means transmits the data to a terminal;
the terminal outputs the information based on the transmitted data.
